(19) United States
(12) Patent Application Publication
(10) Pub. No.: US 2023/0106911 A1
(43) Pub. Date: Apr. 6, 2023

(54) OPTICAL COUPLING OF LIGHT SOURCE AND PHOTONIC INTEGRATED CIRCUIT

(71) Applicant: University College Cork, National University of Ireland, Cork, Cork (IE)

(72) Inventor: Peter O'Brien, Belgooly (IE)

(73) Assignee: University College Cork, National University of Ireland, Cork, Cork (IE)

(21) Appl. No.: 17/959,257

(22) Filed: Oct. 3, 2022

(30) Foreign Application Priority Data
Oct. 1, 2021 (GB) 2114085.0

(51) Int. Cl. G02B 6/42

(52) U.S. Cl. CPC G02B 6/4296; G02B 6/4226; G02B 6/4227; G02B 6/4238; G02B 6/4245

(57) ABSTRACT

A photonic integrated circuit (PIC) assembly that includes a PIC, and a light source mounted on a first carrier substrate, and optically coupled and aligned with the PIC. The first carrier substrate includes a wrap-around metal, that enables the first carrier substrate to be bonded electrically with the PIC using solder bumps, and wherein the wrap-around metal enables the first carrier substrate to be electrically controlled by an external device for facilitating alignment and optical coupling process with the PIC.

The application claims the benefit of United Kingdom Patent Application No. 2114085.0, filed 1 Oct. 2021, the specification of which is hereby incorporated herein by reference.

### BACKGROUND OF THE INVENTION

### Field of the Invention

Embodiments of the invention are directed towards optical coupling of a light source and a Photonic Integrated Circuit (PIC), and more specifically to using micro-optics to couple a laser and the PIC.

### Description of Related Art

PICs are well known in the art as integrated optical circuits and integrated photonic circuits. A PIC is a device that integrates a plurality of photonic functions and typically provides functions for information signals imposed on optical wavelengths typically in the visible spectrum or near infrared such as 850 nm-1650 nm. The primary application for PICs is in the area of fibre-optic communication though applications in other fields such as biomedical and photonic computing are also possible.

PICs typically use a laser source to inject light that drives the components, similar to turning on a switch to inject electricity that drives electronic components. However, PIC devices, in particular silicon and silicon nitride (SiN) devices, do not have an intrinsic light source such as a laser or optical amplifier. There exist several approaches to integrate light sources with PIC devices.

One such approach includes off-packaging light source with fibre coupling between the light source and PIC waveguide. This approach is commonly used in many datacom applications as it ensures that the light source and PIC are independent in terms of reliability and thermal management, where the integration process is based on conventional fibre coupling technology. However, these processes are relatively slow and expensive, resulting in a large module footprint.

Another approach includes direct bonding of the light source on the PIC chip itself, often known as Heterogeneous Integration. The processes such as transfer printing enable the fast integration of light sources on the PIC chip, with optical coupling achieved through end-facet or evanescent coupling. However, a limitation of this process is the lack of device testing and pre-selection prior to the bonding process and the potential for heating of the PIC device due to direct light source integration.

Hence, in view of the above, there is a need for a method and system that is directed towards overcoming the problems with the prior art set out above and developing an assembly process for coupling light source and the PIC, with an objective to maximise coupling efficiency within a small package footprint, while minimising thermal issues.

### BRIEF SUMMARY OF THE INVENTION

In at least one embodiment of the invention, there is provided a photonic integrated circuit (PIC) assembly that comprise a PIC, and a light source mounted on a first carrier substrate, and optically coupled and aligned with the PIC, wherein the first carrier substrate includes a wrap-around metal, that enables the first carrier substrate to be bonded electrically with the PIC using solder bumps, and wherein the wrap-around metal enables the first carrier substrate to be electrically controlled by an external device for facilitating alignment and optical coupling process with the PIC.

In at least one embodiment of the invention, the light source is a laser.

In at least one embodiment of the invention, each of the laser and the PIC includes first and second micro-optical components bonded to respective output facets facing each other, and wherein the first and second micro-optical components are configured to expand an output collimated beam from the laser to relax alignment tolerances between the laser and the PIC to optically couple and align the laser and the PIC.

In one or more embodiments of the invention, the PIC is mounted on a second carrier substrate, and the first and second carrier substrates are mounted on a base substrate.

In at least one embodiment of the invention, the PIC is mounted on a second carrier substrate, and wherein the second carrier substrate acts as a base substrate for mounting the first carrier substrate.

In at least one embodiment of the invention, the side edges of the first and second carrier substrates facing each other, are initially bonded using Ultraviolet (UV) cure epoxies, and later through solder bonding, upon aligning and optically coupling the laser and the PIC.

In at least one embodiment of the invention, the solder bumps are jetted at a location on a bottom edge of the first carrier substrate, to fix and mount the first carrier substrate onto the base substrate upon aligning and optically coupling the laser and the PIC, and wherein electrical bond pads on the base substrate coincide with the wrap around metal on the first carrier substrate to form an electrical contact therein.

In at least one embodiment of the invention, the PIC includes an etched cavity, and the laser on the first carrier substrate is inverted, and inserted into the etched cavity upon aligning and optically coupling the laser and the PIC.

In one or more embodiments of the invention, the first carrier substrate acts as a hermetic seal over the laser and the etched cavity.

In at least one embodiment of the invention, the wrap around metal on the first carrier substrate enables a packaging machine pick-up tool to turn-on and move the first carrier substrate for active alignment and optically coupling process with the PIC.

In one or more embodiments of the invention, there is provided a method for integrating a light source and a photonic integrated circuit (PIC). The method includes optically coupling and aligning a light source mounted on a first carrier substrate with the PIC, and bonding the light source mounted on the first carrier substrate with the PIC, wherein the first carrier substrate includes a wrap-around metal, that enables the first carrier substrate to be bonded electrically with the PIC using solder bumps, and wherein the wrap-around metal enables the first carrier substrate to be electrically controlled by an external device during alignment and optical coupling process with the PIC.

In at least one embodiment of the invention, the method includes providing first and second micro-optical components at output facets of the laser and the PIC, and generating an output collimated beam from the laser to enable the first and second micro-optical components to expand the output collimated beam to relax alignment tolerances between the laser and the PIC to optically couple and align the laser and the PIC.

In at least one embodiment of the invention, the method further includes bonding side edges of the first and second carrier substrates facing each other, first using Ultraviolet (UV) cure epoxies, and later through solder bonding, upon aligning and optically coupling the laser and the PIC.

In at least one embodiment of the invention, the method further includes jetting solder bumps at a location on a bottom edge of the first carrier substrate, to fix and mount the first carrier substrate onto the base substrate upon aligning and optically coupling the laser and the PIC, and wherein electrical bond pads on the base substrate coincide with the wrap around metal on the first carrier substrate to form an electrical contact therein.

In one or more embodiments of the invention, the method further includes inverting the laser on the first carrier substrate, inserting the inverted laser on the first carrier substrate, into an etched cavity of the PIC, upon aligning and optically coupling the laser and the PIC, and bonding the inverted laser on the first carrier substrate and the etched cavity.

In at least one embodiment of the invention, the method further includes electrically connecting a packaging machine pick-up tool with the wrap around metal to turn-on and move the first carrier substrate for active alignment and optically coupling process with the PIC.

One or more embodiments of the invention provide an in-package light source assembly or hybrid integration, which usually involves micro-optics to couple the light source and PIC, thereby enabling a more compact module, while still minimising thermal issues as the devices can be separated to avoid thermal crosstalk. Another advantage includes ability to select known good devices, and ensuring process yields can be maximised.

### BRIEF DESCRIPTION OF THE DRAWINGS

The invention will be more clearly understood from the following description of at least one embodiment thereof, given by way of example only, with reference to the accompanying drawings, in which:

FIG. 1A is a perspective view illustrating optical coupling between a light source and a PIC using two separate carrier substrates to form a PIC assembly, in accordance with one or more embodiments of the invention;

FIG. 1B is a perspective view of a PIC assembly formed by bonding the first carrier substrate with the second carrier substrate and a base substrate, in accordance with one or more embodiments of the invention;

FIG. 2A and FIG. 2B illustrate a wrap around metal on a laser carrier substrate, in accordance with one or more embodiments of the invention;

FIG. 3 is a side view illustrating active alignment of laser with the PIC, when a carrier substrate of the PIC also acts as a base substrate, in accordance with one or more embodiments of the invention;

FIG. 4A is a top perspective view illustrating the optical coupling between the PIC and a laser on carrier, in accordance with one or more embodiments of the invention;

FIG. 4B is a side view of a PIC assembly showing the laser on carrier bonded to the PIC chip, in accordance with one or more embodiments of the invention; and

FIG. 5 is a flowchart illustrating a method for integrating a light source with a PIC, in accordance with one or more embodiments of the invention.

### DETAILED DESCRIPTION OF THE DRAWINGS

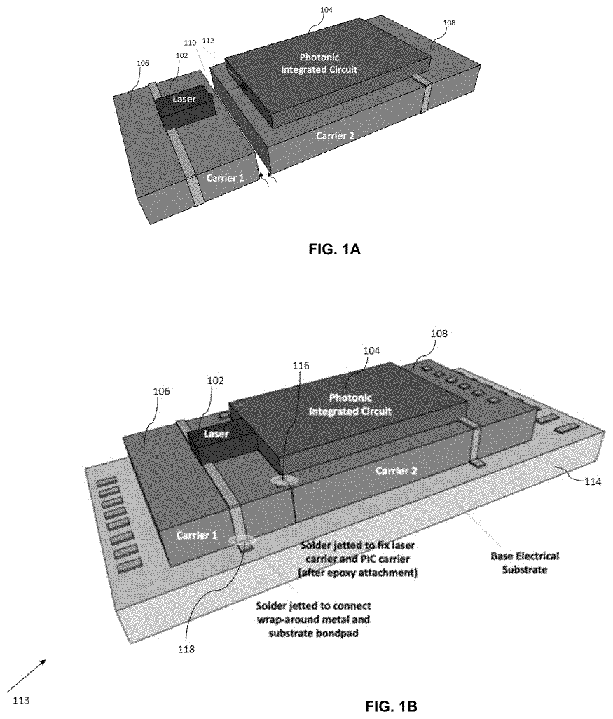

FIG. 1A is a perspective view illustrating optical coupling between a light source 102 and a PIC 104 using two separate carrier substrates to form a PIC assembly, in accordance with one or more embodiments of the invention. In at least one embodiment, the light source 102 is a laser, and is hereinafter also referred to as the laser 102.

As shown herein, the laser 102 is mounted on a first carrier substrate 106, and the PIC 104 is mounted on a second carrier substrate 108. The first and second carrier substrates 106 and 108 are hereinafter also referred to as laser carrier 106 and PIC carrier 108 respectively. The laser 102 is bonded up-side or down-side (flip-chip assembly) on to the first carrier substrate 106. Similarly, the PIC 104 can be bonded up-side or down-side on to the second carrier substrate 108. The first and second carrier substrates 106 and 108 may be made from materials such as ceramic, silicon and glass materials.

Both the laser 102 and PIC 104 include micro-optical components 110 and 112 bonded to their output facets respectively. In at least one embodiment, each of the micro-optical components 110 and 112 includes silicon or fused silica micro-lenses. The pre-fabrication of micro-optical components 110 and 112 can be realised using polymer 3D printing on the device facet. Alternatively, assembly of micro-optical components can be realised using wafer-level micro-optics aligned and bonded to the device facet prior to bonding to respective carrier substrates.

In at least one embodiment of the invention, the micro-optical components 110 and 112 are used to expand an output collimated beam from the laser 102 to relax the alignment tolerance between the laser 102 and the PIC 104. Furthermore, the use of micro-optical components 110 and 112 can compensate for differences in mode size between the laser 102 and the PIC 104. It is to be noted that both translational (x, y, z displacement) and angular alignment tolerances may be considered during this process.

In at least one embodiment of the invention, the PIC 104 is first fixed on the second carrier substrate 108, and then the laser 102 is moved to actively align with the PIC 104 and then bonded (edge to edge). Alternatively, the laser 102 is first fixed on the first carrier substrate 106, and then the PIC 104 is moved to actively align with the laser 102 and then bonded (edge to edge).

FIG. 1B, according to one or more embodiments of the invention, is a perspective view of a PIC assembly 113 formed by bonding the first carrier substrate 106 with the second carrier substrate 108 and a base substrate 114, upon aligning and optically coupling the laser 102 and the PIC 104. Both the first and second carrier substrates 106 and 108 are shown to be mounted on a base electrical substrate 114.

A first connection 116 illustrates bonding of the side edges of the first and second carrier substrates 106 and 108. Such side edges may be initially bonded using Ultraviolet (UV) cure epoxies which enable precision alignment and bonding. Once maximum optical coupling is achieved between the laser 102 and the PIC 104, and the first carrier substrate 106 is fixed in position with respect to the second substrate 108 using the cured epoxy, solder (e.g. micro solder spheres) may be used to provide additional mechanical bonding strength between the first and second carrier substrates 106 and 108. Thus, the edges are first bonded using epoxy which is a rapid process and then followed-up using solder bonding to produce a very strong solder bond which is reflow stable (260° C.) as epoxies are not strong at these reflow temperatures.

A second connection 118 is formed between the first carrier substrate 106 and the base substrate 114. The second connection 118 corresponds to a location 118 where electrical bondpads on the base electrical substrate 114 coincide with a wrap around metal on the laser carrier 106, to fix and mount the laser carrier 106 onto the base electrical substrate 114. The solder jetting of micro solder spheres (e.g. 50 um solder spheres) to the warp-around metal on the laser carrier 106 at the location 118 forms an electrical contact between the laser 102 and the PIC 104.

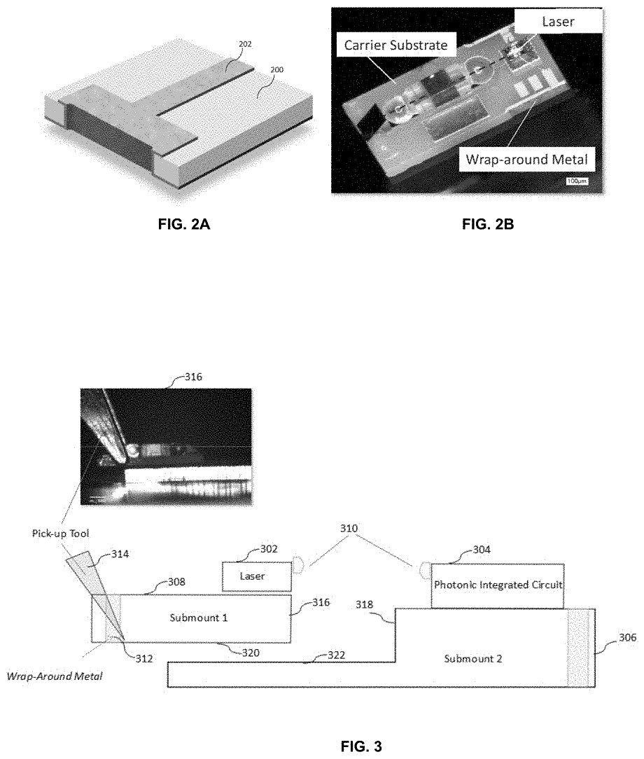

The wrap around metal on the laser carrier 106 is shown clearly with reference to FIG. 2A and FIG. 2B, in that, a laser carrier substrate 200 includes a wrap-around metal 202, according to one or more embodiments of the invention. The wrap-around metal 202 enables the laser carrier substrate 200 to be bonded electrically with other substrates using solder bumps.

Referring back to FIG. 1B, the solder is placed on a bottom edge of the first carrier substrate 106, where the solder can be jetted against the wrap-around metal which runs down the side of the first carrier substrate 106. When the solder is jetted at the bottom of the wrap-around metal and the first carrier substrate 106 is placed on the base electrical substrate 114 which has top-side bondpads, the laser carrier 106 can be electrically connected to substrate bondpads of the base electrical substrate 114.

Thus, the laser substrate 106 has wrap-around metal bondpads which enable the laser 102 to be switched-on and actively aligned and optically coupled to the PIC 104. The wrap-around metal enables the laser 102 to be electrically powered-on during the alignment to the PIC 104, and when the laser 102 is aligned to the PIC 104, the wrap-around metal enables connection to the base electrical substrate 114.

FIG. 3 is a side view illustrating active alignment of laser 302 with the PIC 304, when a carrier substrate 306 of the PIC 304 also acts as a base substrate 306, in accordance with one or more embodiments of the invention.

The PIC 304 is fixed and mounted on the base substrate 306, and the laser 302 is mounted on a laser substrate 308. Both the laser 302 and PIC 304 includes micro-optical components 310 for enabling active alignment of the laser 302 and the PIC 304. The carrier substrate 306 of the PIC 304 is referred to as the base substrate 306, as the laser substrate 308 is mounted and fixed on the carrier substrate 306 upon completion of alignment and optically coupling with the PIC 304.

The laser substrate 308 includes a wrap around metal 312 (similar to the wrap around metal 202 of FIG. 2A). The wrap-around metal 312 enables an external device such as a packaging machine pick-up tool 314 to turn-on the laser substrate 308 for the active alignment process with the PIC 304. The pick-up tool 314 holding a laser on ceramic is shown in detail in an inset image 316. The pick-up tool 314 is made of metal, enabling electrical power to be provided to the laser 302 for active alignment to the PIC device 304. The pick-up tool 314 may be used to move the laser 302 vertically or horizontally in order to align with the PIC 304.

Upon completion of the alignment and optical coupling of the laser 302 and the PIC device 304, the side edges 316 and 318 of the laser substrate 308 and the base substrate 306 respectively may first be bonded using UV cure epoxies, and then using solder bumps. Further, the bottom edge 320 of the laser substrate 308 may be bonded with a top edge 322 of the base substrate 306, by jetting solder bumps at a location where the wrap-around metal 312 coincides with electrical bond pads of the base substrate 306.

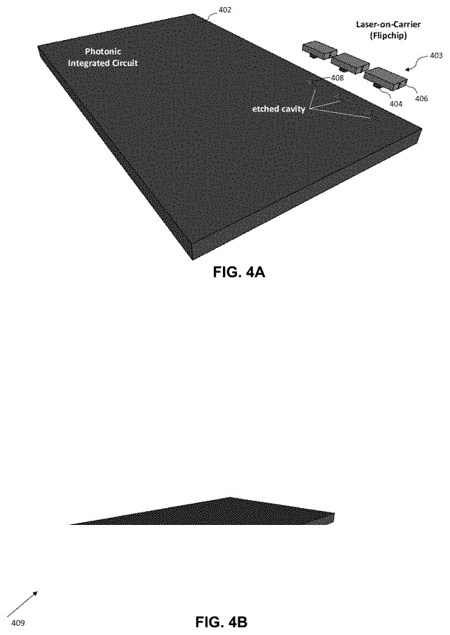

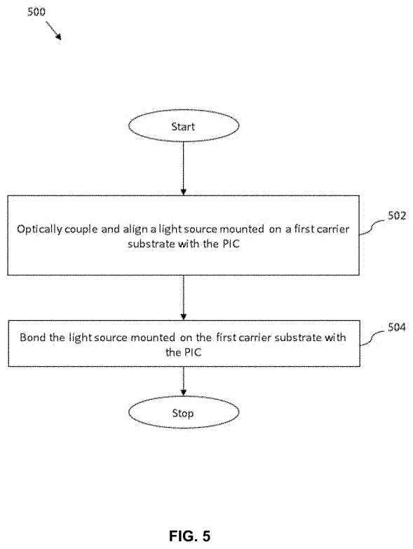

FIG. 4A is a top perspective view illustrating the optical coupling between the PIC 402 and a laser on carrier 403, in accordance with one or more embodiments of the invention. FIG. 4B is a side view of a PIC assembly 409 showing the laser on carrier 403 bonded to the PIC chip 402, according to one or more embodiments of the invention.

The PIC 402 includes multiple etched cavities 408 for directly receiving the laser on carrier 403. The laser on carrier 403 includes a laser 404 mounted on a carrier substrate 406. The laser 404 mounted on the carrier substrate 406 is inverted and placed inside a cavity 408 etched in the PIC 402. The cavity 408 exposes the PIC optical waveguide, such that the laser 404 on the carrier substrate 406 is activity aligned to the PIC waveguide 402. The laser 404 is directly aligned and bonded to the PIC chip 402, without using a carrier substrate for the PIC 402. This approach makes for a more compact assembly.

Further, the laser 404 is actively aligned to the PIC waveguide 402 and initial bonding is achieved using UV cure epoxy. This bond can be further fixed using solder which also enables electrical contact to the laser 404, where the carrier substrate 406 is designed with a wrap-around metal structure. An additional benefit of the PIC assembly 409 is that the carrier substrate 406 acts as a cap or hermetic seal over the laser 402 and the etched cavity 408, thereby protecting the arrangement from environmental factors such as moisture ingression. This improves the long-term reliability of the PIC assembly 409.

FIG. 5 is a flowchart illustrating a method 500 for integrating a light source with a PIC, in accordance with one or more embodiments of the invention.

At step 502, a light source mounted on a first carrier substrate is optically coupled and aligned with the PIC.

At step 504, the light source mounted on the first carrier substrate is bonded with the PIC. The first carrier substrate includes a wrap-around metal, that enables the first carrier substrate to be bonded electrically with the PIC using solder bumps, and wherein the wrap-around metal enables the first carrier substrate to be electrically controlled by an external device during alignment and optical coupling process with the PIC.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the one or more embodiments hereinbefore described but may be varied in both construction and detail.

1. A photonic integrated circuit (PIC) assembly comprising:
a PIC; and
a light source mounted on a first carrier substrate, and optically coupled and aligned with the PIC,
wherein the first carrier substrate includes a wrap-around metal, that enables the first carrier substrate to be bonded electrically with the PIC using solder bumps, and
wherein the wrap-around metal enables the first carrier substrate to be electrically controlled by an external device for facilitating alignment and optical coupling process with the PIC.

2. The photonic integrated circuit (PIC) assembly as claimed in claim 1, wherein the light source is a laser.

3. The photonic integrated circuit (PIC) assembly as claimed in claim 1, wherein the light source is a laser and each of the laser and the PIC includes first and second micro-optical components bonded to respective output facets facing each other, and wherein the first and second micro-optical components are configured to expand an output collimated beam from the laser to relax alignment tolerances between the laser and the PIC to optically couple and align the laser and the PIC.

4. The photonic integrated circuit (PIC) assembly as claimed in claim 1, wherein the light source is a laser and the PIC is mounted on a second carrier substrate, and the first carrier substrate and the second carrier substrate are mounted on a base substrate.

5. The photonic integrated circuit (PIC) assembly as claimed in claim 1, wherein the light source is a laser and the PIC is mounted on a second carrier substrate, and wherein the second carrier substrate acts as a base substrate for mounting the first carrier substrate.

6. The photonic integrated circuit (PIC) assembly as claimed in claim 4, wherein side edges of the first carrier substrate and the second carrier substrate facing each other, are initially bonded using Ultraviolet (UV) cure epoxies, and later through solder bonding, upon aligning and optically coupling the laser and the PIC.

7. The photonic integrated circuit (PIC) assembly as claimed in claim 4, wherein the solder bumps are jetted at a location on a bottom edge of the first carrier substrate, to fix and mount the first carrier substrate onto the base substrate upon aligning and optically coupling the laser and the PIC, and wherein electrical bond pads on the base substrate coincide with the wrap-around metal on the first carrier substrate to form an electrical contact therein.

8. The photonic integrated circuit (PIC) assembly as claimed in claim 2, wherein the PIC includes an etched cavity, and the laser on the first carrier substrate is inverted and inserted into the etched cavity upon aligning and optically coupling the laser and the PIC.

9. The photonic integrated circuit (PIC) assembly as claimed in claim 2, wherein the PIC includes an etched cavity, and the laser on the first carrier substrate is inverted and inserted into the etched cavity upon aligning and optically coupling the laser and the PIC wherein the first carrier substrate acts as a hermetic seal over the laser and the etched cavity.

10. The photonic integrated circuit (PIC) assembly as claimed in claim 1, wherein the wrap-around metal on the first carrier substrate enables a packaging machine pick-up tool to turn-on and move the first carrier substrate for active alignment and optically coupling process with the PIC.

11. A method for integrating a light source with a photonic integrated circuit (PIC), comprising:
optically coupling and aligning a light source mounted on a first carrier substrate with the PIC; and
bonding the light source mounted on the first carrier substrate with the PIC, wherein the first carrier substrate includes a wrap-around metal, that enables the first carrier substrate to be bonded electrically with the PIC using solder bumps, and wherein the wrap-around metal enables the first carrier substrate to be electrically controlled by an external device during alignment and optical coupling process with the PIC.

12. The method as claimed in claim 11, wherein the light source is a laser.

13. The method as claimed in claim 11, wherein the light source is a laser and further comprising:
providing first and second micro-optical components at output facets of the laser and the PIC; and
generating an output collimated beam from the laser to enable the first and second micro-optical components to expand the output collimated beam to relax alignment tolerances between the laser and the PIC to optically couple and align the laser and the PIC.

14. The method as claimed in claim 11, wherein the light source is a laser, the PIC is mounted on a second carrier substrate, and the first carrier substrate and the second carrier substrate are mounted on a base substrate.

15. The method as claimed in claim 11, wherein the light source is a laser the PIC is mounted on a second carrier substrate, and wherein the second carrier substrate acts as a base substrate for mounting the first carrier substrate.

16. The method as claimed in claim 14, further comprising
bonding side edges of the first carrier substrate and the second carrier substrate facing each other, first using Ultraviolet (UV) cure epoxies, and later through solder bonding, upon aligning and optically coupling the laser and the PIC.

17. The method as claimed in claim 14, further comprising
jetting the solder bumps at a location on a bottom edge of the first carrier substrate, to fix and mount the first carrier substrate onto the base substrate upon aligning and optically coupling the laser and the PIC, and wherein electrical bond pads on the base substrate coincide with the wrap-around metal on the first carrier substrate to form an electrical contact therein.

18. The method as claimed in claim 11, wherein the light source is a laser and further comprising
inverting the laser on the first carrier substrate; and
inserting the laser that is inverted on the first carrier substrate, into an etched cavity of the PIC, upon aligning and optically coupling the laser and the PIC; and
bonding the laser that is inverted on the first carrier substrate and the etched cavity.

19. The method as claimed in claim 18, wherein the first carrier substrate acts as a hermetic seal over the laser and the etched cavity.

20. The method as claimed in claim 11, further comprising electrically connecting a packaging machine pick-up tool with the wrap-around metal to turn-on and move the first carrier substrate for active alignment and optically coupling process with the PIC.
